(19) United States
(12) Patent Application Publication
(10) Pub. No.: US 2020/0407929 A1
(43) Pub. Date: Dec. 31, 2020

(54) AUTOMATIC ROAD MARKING SYSTEM

(71) Applicants: Gianni FALCHETTI, Gualdo Cattaneo (PG) (IT); Cinzia MOLINARI, Gualdo Cattaneo (PG) (IT)

(72) Inventor: Gianni FALCHETTI, Gualdo Cattaneo (PG) (IT)

(21) Appl. No.: 16/977,334

(22) PCT Filed: Feb. 27, 2019
(86) PCT No.: PCT/EP2019/054819

§ 371 Date: Sep. 1, 2020

(30) Foreign Application Priority Data
Mar. 8, 2018 (IT) 102018000003365

(51) Int. Cl. E01C 23/16; E01C 23/22; G05D 1/02

(52) U.S. Cl. CPC E01C 23/163; E01C 23/222; G05D 1/0274; G05D 1/0246; G05D 1/0238; G05D 1/0278

(57) ABSTRACT

An automatic road marking system including a pilot vehicle provided with a first GPS module, cameras, a tank and a control unit with wireless transmitter and an automatic guided vehicle (AGV). The AGV has a motor and a steering system, a second GPS module, spray nozzles, a hydraulic circuit, and an electronic control unit (ECU) with a receiver coupled with the transmitter of the control unit of the pilot vehicle. The system also includes a third GPS module suitable for being disposed in a fixed position in the proximity of the carriageway or on the carriage way where the road markings are to be made.

The present invention relates to an automatic road marking system.

As it is known, roads are generally provided with road markings, consisting in suitably colored lines that are marked on the road surface in such a way to be distinguished from the road surface.

Various types of road markings machines are known on the market. Such types of systems, which are commonly known as road marking machines, comprise a tank with paint for road markings and spray nozzles connected to the tank by means of a hydraulic system in order to spray the paint on the road surface and make the road markings.

In order to make the road markings, it is firstly necessary to mark the position where the road markings are to be made, eventually masking the road with adhesive tape that needs to be glued on the asphalt. Afterwards, the operator drives the road marking machine, placing the spray nozzle in the position shown by the masking tape where the road markings are to be made.

In case of new road markings, the user needs to measure the road in order to exactly identify the position where the road markings are to be made.

It appears evident that the systems of the prior art that are used to make roads markings are time-consuming and complicated, requiring the presence of several operators to measure the road, apply the masking tape and make the road markings as indicated.

Moreover, given the fact that many operations are carried out by the operator, it appears evident that the traditional processes are inaccurate and unreliable because of possible human errors.

The purpose of the present invention is to eliminate the drawbacks of the prior art by disclosing an automatic road marking system capable of minimizing the use of operators.

Another purpose of the present invention is to provide such a road marking system that is accurate, reliable, rapid and easy to use.

These purposes are achieved according to the invention with the characteristics of the independent claim 1.

Advantageous embodiments of the invention appear from the dependent claims.

The system of the invention is defined in claim 1.

The advantages of the system according to the invention are evident. In fact, the use of such a system only requires the presence of one operator to drive the pilot vehicle. All road marking operations are automatically made by the automatic guided vehicle (AGV). Therefore, the operator in charge of driving the pilot vehicle does not need to be accurate because the AGV moves autonomously and precisely, placing itself in the correct position to make the road markings.

Additional features of the invention will appear manifest from the detailed description below, which refers to a merely illustrative, not limiting embodiment, as illustrated in the attached figures, wherein:

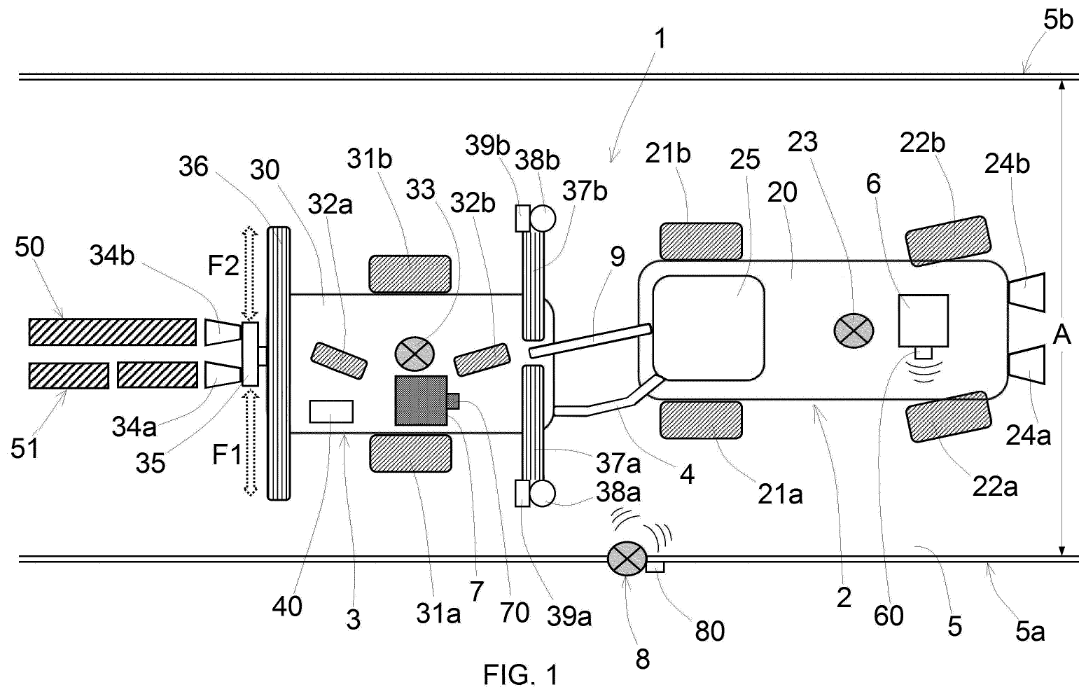

FIG. 1 is a diagrammatic top view of the road marking system according to the invention.

With reference to the Figure, the system according to the invention is disclosed, which is generally indicated with reference numeral (1).

The Figure shows a road surface (5) of a carriageway with two lateral edges (5a, 5b). Road markings are to be made on the road surface (5), consisting for example in a solid line (50) and a broken line (51).

The system (1) comprises a pilot vehicle (2) and an automatic guided vehicle (AGV) (3).

The pilot vehicle (2) is driven by a pilot and is suitable for traveling along the road surface (5) of the carriageway. The pilot vehicle comprises a body (20) supported by driving wheels (21a, 21b) and steering wheels (22a, 22b). Obviously, also the steering wheels (22a, 22b) can be driving wheels. The pilot vehicle can be provided with an internal combustion or electric engine to actuate the driving wheels.

A first GPS module (23) suitable for detecting the position of the pilot vehicle is mounted in the body (20) of the pilot vehicle.

Cameras (20) are mounted in a front part of the body and directed frontally in order to take images of the entire width (A) of the carriageway of the road surface (5). Two cameras (24a, 24b) can be provided and respectively disposed on the right and on the left relative to the forward traveling direction of the pilot vehicle.

The pilot vehicle (2) comprises a control unit (6) connected to the first GPS module (23) and to the cameras (24a, 24b) to receive data on the position of the vehicle detected by the first GPS module (23) and on the images taken by the cameras (24a, 24b),

A wireless transmitter (60) is connected to the control unit (6) to transmit the data received from the control unit.

A tank (25) is mounted in a back portion of the body (20) of the pilot vehicle. The tank (25) is suitable for being filled with road marking paint.

The AGV (3) does not need to be driven by a pilot. The AGV (3) comprises a body (30) supported by driving wheels (31a, 31b) and swiveling wheels (22a, 22b) in such a way to curve in any direction. The AGV comprises an electric motor connected to the driving wheels and a steering system. An electronic control unit (ECU) (7) controls the motor and the steering system of the AGV, in such a way to move the AGV in the desired direction without requiring the presence of a pilot.

Although, for clarity reasons, the AGV (3) shown in the figures is slightly shorter than the pilot vehicle (2), it must be considered that the AGV is much shorter and much smaller than the pilot vehicle because of the fact that it does not need to be driven by a pilot and it is not provided with a paint tank. In view of the above, the AGV is easy to handle and can easily move and curve along the carriageway of the road surface (5).

A second GPS module (33) suitable for detecting the position of the AGV is mounted in the body (30) of the AGV.

Spray nozzles (34a, 34b) are mounted in a back part of the AGV and hydraulically connected to the tank (25) of the pilot vehicle. A flexible conduit (4) puts the tank (25) of the pilot vehicle in communication with a hydraulic system (40) provided in the AGV and connected to the spray nozzles (34a, 34b).

A coupling (9) is connected to a back portion of the pilot vehicle and to a front portion of the AGV in order to prevent the risk of moving the pilot vehicle away from the AGV, pulling the flexible conduit (4) and damaging it.

The hydraulic system (40) comprises one or more pumps suitable for extracting the paint from the tank (25) and sending it to the spray nozzles (34a, 34b).

The spray nozzles (34a, 34b) are supported by a trolley (35) that is slidingly mounted in a guide (36) disposed in the back portion of the body (30) of the AGV, in transverse direction relative to the forward traveling direction of the system (1). The trolley (35) is moved along the guide (36) by means of actuators, such as for example cylinder-piston systems, motorized systems with rack, worm, belt and the like.

In view of the above, the spray nozzles (34a, 34b) can be moved in the directions of the arrows (F1, F2) according to the road marking requirements.

Although two spray nozzles (34a, 3b) mounted on a single trolley (35) are shown in the figures, each spray nozzle can be mounted on a trolley.

Optical sensors (38a, 38b) are mounted in the AGV and directed towards the road surface (5) of the carriageway in order to detect the presence of existing road markings.

Proximity sensors (39a, 39b) are mounted in the AVG and directed towards the road surface (5) of the carriageway in order to detect the presence of obstacles, such as stones, poles and the like, on the road surface or on the edges of the carriageway.

Advantageously, two supporting arms (37a, 37b) project laterally rightwards and leftwards from a front portion of the body (30) of the AGV. The optical sensors (38a, 38b) and the proximity sensors (39a, 39b) are mounted on the supporting arms (37a, 37b).

In addition to being connected to the motor and to the steering system of the AGV, the electronic control unit (ECU) (7) of the AGV is also connected to the second GPS module (33), to the hydraulic system (40), to the actuators of the trolley (35) of the spray nozzles, to the optical sensors (38a, 38b) and to the proximity sensors (39a, 39b).

A receiver (70) is connected to the ECU (7) of the AGV to receive data from the transmitter (60) of the control unit of the pilot vehicle.

The system (1) comprises a third GPS module (8) suitable for being disposed on an edge (5a) of the road surface of the carriageway in order to detect a fixed reference position. The third GPS module (8) has a transmitter (80) coupled with the control unit (6) of the pilot vehicle and with the ECU (7) of the AGV in order to transmit data on the fixed position to the control unit (6) of the pilot vehicle and to the ECU (7) of the AGV.

The operation of the system (1) of the invention is described below.

A mapping of the road is necessary before making new roads markings on the road surface (5). Such mapping is made only by the pilot vehicle (2) without needing the AGV.

The third GPS module (8) is disposed in a fixed position, for example on an edge (5a) of the road surface in order to have a fixed reference position.

The AGV is detached from the pilot vehicle, disconnecting the coupling (9) and the flexible conduit (4). Therefore, only the pilot vehicle (2) travels on the carriageway of the road surface (5) in order to map a section of the carriageway. Said mapping is made by storing the width (A) of the carriageway in the control unit (6) of the pilot vehicle, as well as various distances between the third GPS module (8), which is fixed, and the first GPS module (23), which moves along with the pilot vehicle.

To that end, the control unit (6) is provided with a mapping software of known type, which is not illustrated in detail, which detects the width of the carriageway (A) from the images of the cameras (24a, 24b) and the distance between the third GPS module (8) and the first GPS module (23) during the forward traveling of the pilot vehicle.

After completing the mapping of a road section, the mapping data is transferred from the control unit (6) of the pilot vehicle to the ECU (7) of the AGV. The pilot vehicle (2) returns to the beginning of the mapped road section, and the AGV is fixed to the pilot vehicle (2), connecting the coupling (9) and the flexible conduit (4).

Now, given the fact that the ECU (7) of the AGV has acquired the mapping of the road, the AGV is completely autonomous and can autonomously move (without being pulled by the pilot vehicle) to make the road markings on the road surface (5) of the carriageway. It must be considered that the connection between the pilot vehicle and the AGV is only necessary to supply the paint from the tank (25) of the pilot vehicle because the AGV is small and has no space for a paint tank.

The ECU (7) of the AGV receives data on a fixed reference point from the third GPS module (8) and data from the second GPS module (33) that indicates the position of the AGV relative to the fixed reference point. In view of the above, the ECU knows the position of the AGV in real time and can guide the AGV to the position where the road marking is to be made. Moreover, the ECU moves the trolley (35) that supports the spray nozzles (34a, 34b) in such a way to place the spray nozzles exactly in the position where the road markings are to be made.

It must be noted that the guide (36) whereon the trolley (35) with the spray nozzles slides protrudes laterally relative to the body (30) of the AGV. Therefore, during the forward travel of the AGV, such a guide (36) may hit an obstacle that is found on the road surface of the carriageway. Such a problem is solved by the proximity sensors (39a, 39b) that detect the presence of obstacles on the carriageway. Accordingly, the AGV is steered by the ECU in order to avoid the detected obstacles.

The road mapping is not necessary when going over the existing road markings of the road surface (5). In such a case, the optical sensors (38a, 3b) of the AGV detect the presence of the existing road markings on the road surface. The third GPS module (8) and the second GPS module (33) send data to the ECU (7) on the position of the AGV relative to the fixed reference point of the third GPS module. Therefore, the ECU controls the actuation of the spray nozzles (34a, 34b) in such a way to go over the existing road markings.

It must be noted that the optical sensors (38a, 38b) are capable of detecting broken lines (51) where the presence of paint is alternated with the lack of paint. In such a case, the spray nozzle used to go over the broken line is actuated intermittently, according to the detection made by the optical sensors. In view of the above, the paint is sprayed only on the painted portion and not on the unpainted portion of the broken line.

Numerous equivalent variations and modifications can be made to the present embodiment of the invention, which are within the reach of an expert of the field and fall in any case within the scope of the invention as disclosed by the attached claims.

1. Automatic road marking system comprising a pilot vehicle and an automatic guided vehicle (AGV), said pilot vehicle comprising:
a first GPS module suitable for detecting a position of the pilot vehicle;
cameras directed towards the front in such way to take images of a width of a carriageway of a road surface;
a control unit connected to the first GPS module and to the cameras to receive data on the position of the vehicle detected by the first GPS module and on the images taken by the cameras;
a wireless transmitter connected to the control unit to transmit the data received from the control unit; and
a tank suitable for being filled with road marking paint;
said AGV comprising:
a motor and a steering system;
a second GPS module suitable for detecting a position of the AGV;
spray nozzles suitable for spraying road marking paint on the road surface;
a hydraulic circuit hydraulically connected to the spray nozzle and to the tank of the pilot vehicle to supply the paint from the tank to the spray nozzle; and
an electronic control unit (ECU) connected to the motor, to the steering system of the AGV, to the second GPS module and to the hydraulic system; and
a receiver connected to the ECU of the AGV and coupled to the transmitter of the control unit of the pilot vehicle in order to receive data from the transmitter of the control unit of the pilot vehicle; said system also comprising:
a third GPS module suitable for being disposed in a fixed position in the proximity of the carriageway or in the carriageway where the road markings are to be made; and
a wireless transmitter connected to said third GPS module and coupled with said control unit of the pilot vehicle and with said ECU of the AGV to transmit data to the control unit of the pilot vehicle and to the ECU of the AGV, indicating the fixed position wherein the third GPS module is disposed.

2. The system of claim 1, said system further comprising:
a flexible conduit that puts the tank of the pilot vehicle in communication with the hydraulic system of the AGV; and
a coupling connected to a back portion of the pilot vehicle and to a front portion of the AGV.

3. The system of claim 1, wherein said AGV comprises:
a guide;
at least one trolley supporting said spray nozzles, said trolley being slidingly mounted in said guide; and
actuators suitable for moving the trolley along said guide, said actuators being connected to and controlled by said ECU of the AGV.

4. The system of claim 1, wherein said AGV comprises optical sensors directed towards the road surface of the carriageway to detect the presence of existing road markings; said optical sensors being connected to the ECU of the AGV.

5. The system of claim 1, wherein said AGV comprises proximity sensors directed towards the road surface of the carriageway in order to detect the presence of obstacles on the road surface; said proximity sensors being connected to the ECU of the AGV.

6. The system of claim 4, wherein said AGV comprises two supporting arms that project laterally rightwards and leftwards from a front portion of the AGV to support one or more of said optical sensors and said proximity sensors.

7. The system of claim 1, wherein said control unit of the pilot vehicle contains a mapping software suitable for mapping the road surface according to the images taken by said cameras and to the position data detected by said first GPS module disposed in the pilot vehicle and by said third GPS module disposed in a fixed position in the proximity of the carriageway or in the carriageway.

8. Method for the automatic making of road markings, with a system according to claim 1, comprising the following steps:
disposing the third GPS module in a fixed position in the proximity of the carriageway or on the road surface of the carriageway where the road markings are to be made;
mapping a section of the carriageway by means of said pilot vehicle and storing mapping data in said control unit of the pilot vehicle;
transferring the mapping data of the control unit of the pilot vehicle to the ECU of the AGV; and
moving the AGV to a position where the road markings are to be made and spraying the paint by means of the spray nozzles of the AGV in the position where the road markings are to be made.
